(19) United States
(12) Patent Application Publication
(10) Pub. No.: US 2020/0153726 A1
(43) Pub. Date: May 14, 2020

(54) METHOD AND APPARATUS FOR DYNAMIC TRACK ALLOCATION IN A NETWORK

(71) Applicant: Trilliant Networks, Inc., Cary, NC (US)

(72) Inventor: Michel Veillette, Waterloo (CA)

(21) Appl. No.: 16/676,783

(22) Filed: Nov. 7, 2019

Related U.S. Application Data
(60) Provisional application No. 62/757,343, filed on Nov. 8, 2018.

(51) Int. Cl. H04L 12/733; H04L 12/775; H04L 12/911

(52) U.S. Cl. CPC H04L 45/122; H04L 45/20; H04L 47/821; H04L 47/781; H04L 47/826; H04L 45/58

(57) ABSTRACT

A method for dynamic track allocation in a network comprising accessing a message to be routed to a target node; receiving from a path computation element (PCE), a track from the first node to the target node, wherein the track includes at least any intermediate nodes that provide a path from the first node to the target node, wherein the track comprises one or more allocated link resources to the first node, to any intermediate nodes, and to the target node; assigning a track identifier and an expiration time to the defined track; appending the assigned link resources, expiration time and track identifier to the message; and transmitting the message from the first node to the target node, wherein transmitting causes subsequent messages with the same assigned track identifier to be routed through the network along the same route and using the link resources configured by the message.

### CROSS-REFERENCE TO RELATED APPLICATIONS

This application claims priority to U.S. Provisional Patent Application Ser. No. 62/757,343 filed Nov. 8, 2018, which is incorporated by reference herein in its entirety.

### BACKGROUND

### Field

Embodiments of the present invention generally relate to track allocation and more specifically, to a method and system for dynamic track allocation in a network.

### Description of the Related Art

Mesh networks consist of network nodes that connect directly, dynamically, and non-hierarchically to other nodes and cooperate with one another to efficiently route data through the network. Some mesh network nodes can dynamically serve as a router for every other node. In that way, even in the event of a failure of some nodes, the remaining nodes may continue to communicate with each other and if necessary, serve as downlinks/uplinks for other nodes.

Currently, the Internet Engineering Task Force (IETF) 6TiSCH Operation sublayer (6TOP) protocol allows for allocation of resources in a network; however, IETF 6TOP uses a three or four-way handshake, which increases the traffic within the network. Furthermore, network resources need to be allocated in advance to allow their use by the routed IP traffic. This static allocation of resources is inefficient in networks for which traffic flow and routing paths are constantly changing.

Today, some applications targeted for mesh network deployments, for example distribution automation, have specific real-time requirements, such as strict latency requirements. Furthermore, sharing of a common mesh network infrastructure between multiple applications with different latency and bandwidth requirements may also be required. As such, in a resource constrained network, it is important to be able to quickly and efficiently allocate and release network resources in the course of normal messages without the need to send explicit configuration messages.

Therefore, there is a need for a method and apparatus for dynamic track allocation in a network.

### SUMMARY

An apparatus and/or method is provided for dynamic track allocation in a network substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a diagram of an exemplary network implementing dynamic track allocation, according to one or more embodiments of the invention;

FIG. 2 depicts a block diagram of an exemplary network node for use within a routed network implementing dynamic track allocation, according to one or more embodiments of the invention;

FIG. 3 depict a flow diagram for a method of dynamic track allocation in a network, according to one or more embodiments of the invention;

FIG. 4 depicts a flow diagram for a method for managing a message queue, according to one or more embodiments of the invention;

FIGS. 5A, 5B, 5C, and 5D depict a depict a sequence diagram of two adjacent nodes, of a track, according to one or more embodiments of the invention;

FIG. 6 depicts a diagram of exemplary tracks established between a source node and a destination node, according to one or more embodiments of the invention; and

FIGS. 7A and 7B depict a possible slot frame and timeslots in a time-slotted channel hopping (TSCH) network for the example described by FIG. 6, according to one or more embodiments of the invention.

While the method and apparatus are described herein by way of example for several embodiments and illustrative drawings, those skilled in the art will recognize that the method and apparatus for dynamic track allocation in a network is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for dynamic track allocation in a network defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. Although the word “node” is used herein, those skilled in the art will appreciate that the disclosed invention may be implemented on any network device.

### DETAILED DESCRIPTION OF EMBODIMENTS

Embodiments of the invention provide a system and method for dynamic track allocation in a mesh network. A centralized management of network resources is a path computation element (PCE) that can allocate a new track to be used to transfer a message from a source node in the network to a destination node. The source node appends to the message a track identifier, an expiration time, and for each node within the path, one or more link resources allocated by the PCE to this node for downstream transmission, and link resources to be allocated for upstream transmission. Multiple link resources may be assigned to a same track to increase the amount of bandwidth allocated for transmission. Alternately, instead of allocating unused link resources to a new track, the PCE may assign already allocated link resources to share the bandwidth between multiple tracks. In some embodiments, a channel offset is specified to be used for transmission within these link resources. Once appended to the message, the PCE hands off the message for transmission. At each node, the assigned link resources (e.g. timeslot, channel offset, transmit vs. receive, and the destination address of nodes that are configured to listen) are configured based on the information appended in the message by the source node. During the transfer of this first message, each node also records the track identifier in conjunction with the next and previous addresses. This information is than used to forward the subsequent messages on this track using, for example Multiprotocol Label Switching (MPLS).

Various embodiments of a method and apparatus for dynamic track allocation in a network are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on digital signals stored within a memory of a specific apparatus or special purpose computing device or platform. In the context of this specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device can manipulate or transforming signals, typically represented as physical electronic or magnetic quantities within memories, registers, or other information storage devices, transmission devices, or display devices of the special purpose computer or similar special purpose electronic computing device. As used herein, the term device may include a mesh device, a routed device, or any device or node in a network.

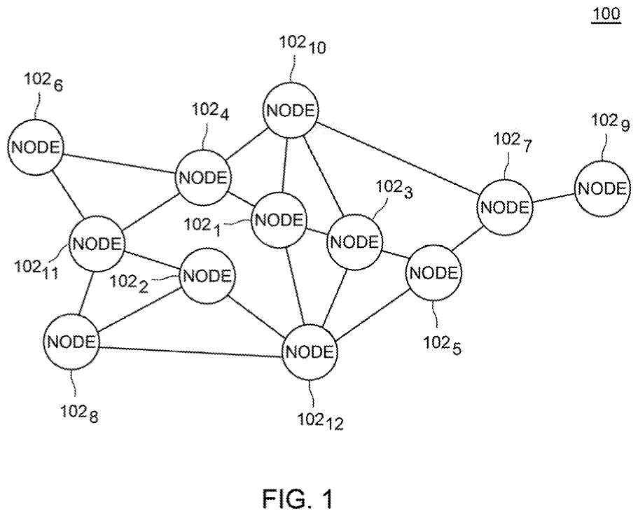

FIG. 1 is a graphical depiction of a network 100 comprising connected nodes 102₁, 102₂, 102₃, 102₄, 102₅, 102₆, 102₇, 102₈, 102₉, 102₁₀, 102₁₁, 102₁₂ (collectively referred to as nodes 102), according to one or more embodiments of the invention. The nodes 102 are interconnected to each other such that multiple paths exist between each node 102. An exemplary network that may utilize and benefit from the present invention is a mesh network. Those skilled in the art can realize from the following disclosure that other network topologies, both wired and wireless, may find benefit by using the present invention.

The present invention is a method and apparatus dynamic track allocation in a network 100. In one embodiment of the invention, a source node 102ₓ (where x is an integer), for example, node 102₁ generates a message for transmission to a destination node 102_{y} (where y is an integer), for example, node 102₆. In some embodiments, the source node 102₁ may be a path computation element (PCE) that computes paths through the network on behalf of the nodes. In some embodiments, the PCE may be an entity running at the boundary or outside the managed network. The PCE allocates a set of link resources from the source node 102₁ to the destination node 102₆ that define a track from the source node 102₁ to the source node 102₆. The defined track is bidirectional. The PCE assigns an identifier to the track and a track expiration time. The source node 102₁ then appends the defined track and track identifier to the message. In some embodiments, the PCE allocates a second set of link resources from the destination node 102₆ to the source node 102₁. In such embodiments, the second set of link resources is also appended to the message.

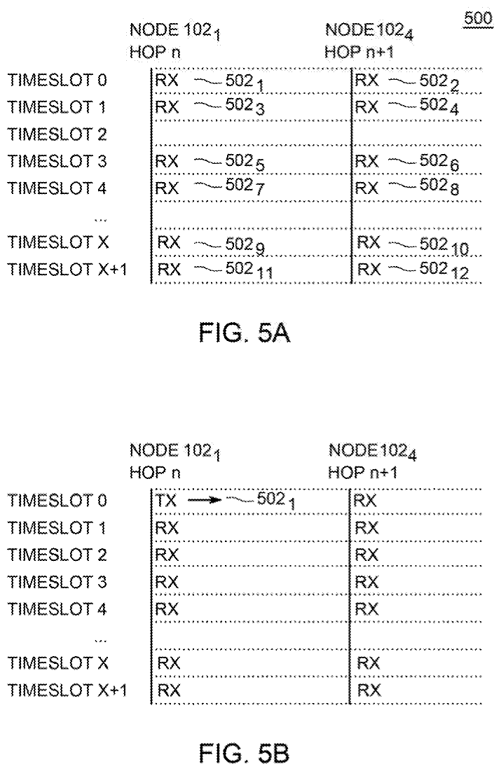

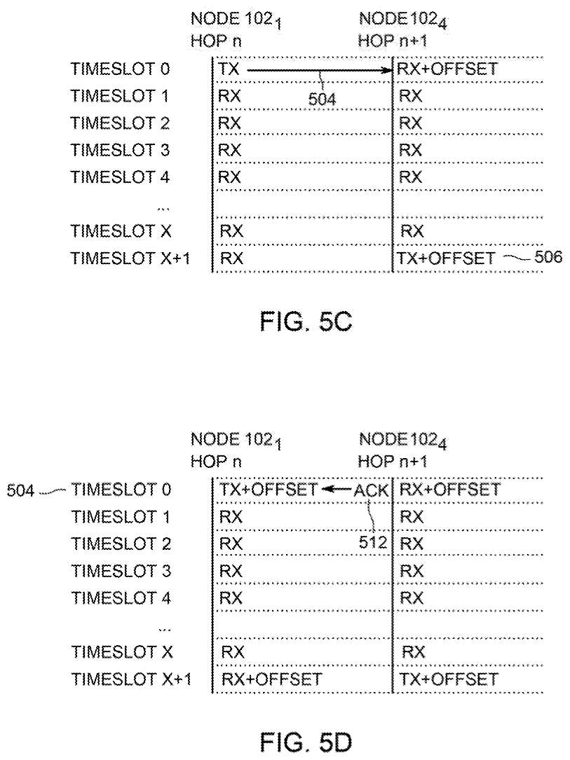

In some embodiments, node 102₁ is a border router that acts as an access point to network 100 routing messages to and from this network. The message is then transmitted from the source node 102₁ to the destination node 102₆. This process is described in further detail with respect to FIGS. 5A, 5B, 5C, 5D, and 5E, below.

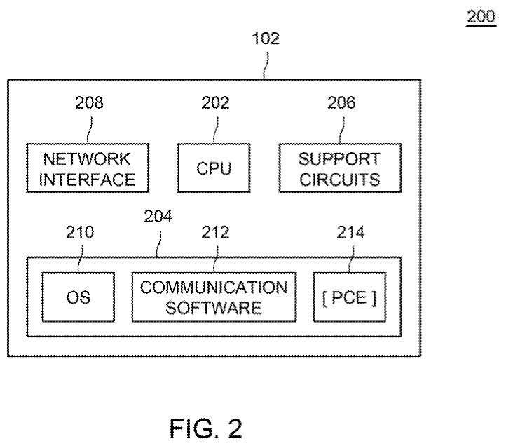

FIG. 2 is a block diagram 200 of a node 102. The node 102 may be a one or more individual Internet of Things (IoT) devices, such as meters, sensors, streetlights, and the like that may benefit from connection to a computer or communications network.

The node 102 comprises a CPU 202, support circuits 206, memory 204 and a network interface 208. The CPU 202 may comprise one or more readily available microprocessors or microcontrollers. The support circuits 206 are well known circuits that are used to support the operation of the CPU and may comprise one or more of cache, power supplies, input/output circuits, network interface cards, clock circuits, and the like. Memory 204 may comprise random access memory, read only memory, removable disk memory, flash memory, optical memory or various combinations of these types of memory. The memory 204 is sometimes referred to as main memory and may, in part, be used as cache memory or buffer memory. The memory 204 stores various forms of software and files, such as, an operating system (OS) 210, communication software 212 and the optional path computation element (PCE) 214 code implemented by one of these nodes. The operating system 210 may be one of several well-known operating systems or real time operating systems such as FreeRTOS, Contiki, LINUX, WINDOWS, and the like.

The network interface 208 connects the node 102 to the network 100. The network interface 208 may facilitate a wired or wireless connection to other nodes. In some embodiments, for example when node 102 is a border router, node 102 may have multiple interfaces 208 for routing within the network 100 as well as to connect to another network.

Link resources or a subset of the link resources are managed by a centralized entity (i.e. a path computation element (PCE) (not shown)), which may be remote from the network nodes. In one embodiment of the invention, the PCE is used to increase the efficiency of a network by quickly and efficiently assigning tracks through the track allocation process in the course of normal messages without the need to send explicit configuration messages. To allocate a track, the PCE computes the route between source node 102₁ and the destination node 102₆ and then allocates to the source, the intermediate and destination nodes, one or multiple link resources for downstream and for upstream transmission.

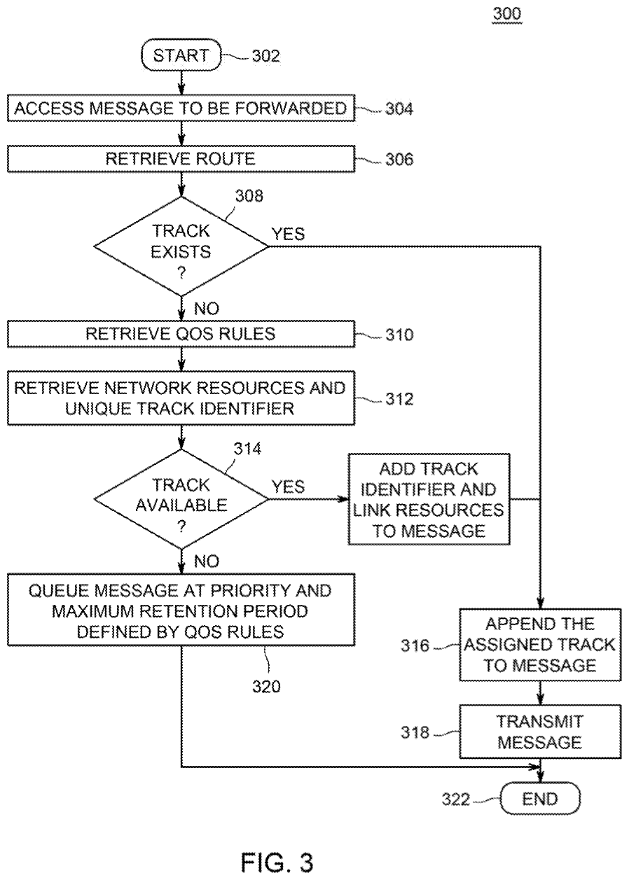

FIG. 3 depicts a method 300 for dynamic track allocation, according to one or more embodiments of the invention. The method 300 may be performed on a node in a network. In some embodiments, the node is a border router. The method 300 starts at step 302 and proceeds to step 304.

At step 304, a message is determined to be ready to be forwarded to the network. The message may have been received by the current node or is generated by the current node. The message is to be routed to a target node in the managed network on its way to a destination node. At step 306, the route to the target node within the managed network is retrieved from the routing protocol. A route is the series of nodes traversed to get from the source node to the destination node. Each step from a first node to a second node is referred to has a hop. A track follows the route and specifies the link resources used at each hop.

At step 308, it is determined whether a track already exists for this destination. If a track already exists for the destination, the method proceeds to step 316. If it is determined that a track does not currently exist for the track, then the method proceeds to step 310, where quality of service (QOS) rules associated with this traffic are retrieved. The retrieval of QOS rules may be performed by the PCE, locally by the node, or a combination of both.

At step 312, network resources are retrieved. The node retrieves the network resources and a unique track identifier from the PCE. The track is based on a maximum bandwidth and maximum channel sharing allowed by the QOS rules. At step 314, it is determined whether the retrieved network resources are currently available to route the message. If it is determined that all network resources are currently in used and the sharing of link resources is not allowed or possible, then the method proceeds to step 320, where the message is temporary queued until network resources are freed. Queued message can be prioritized to avoid timeouts or to apply quality of service (QOS) rules. Queued messages also get assigned a limited queuing lifetime to avoid transmitting stale messages. From step 320 the method proceeds to step 322 where the method ends.

However, if at step 314, it is determined that network resource links are available, then at step 315 the link resources and track expiration time are appended to the message and the method proceeds to step 316.

At step 316, the assigned track identifier is appended to the message. At step 318, the message is transmitted and the message proceeds to step 322 where the method 300 ends.

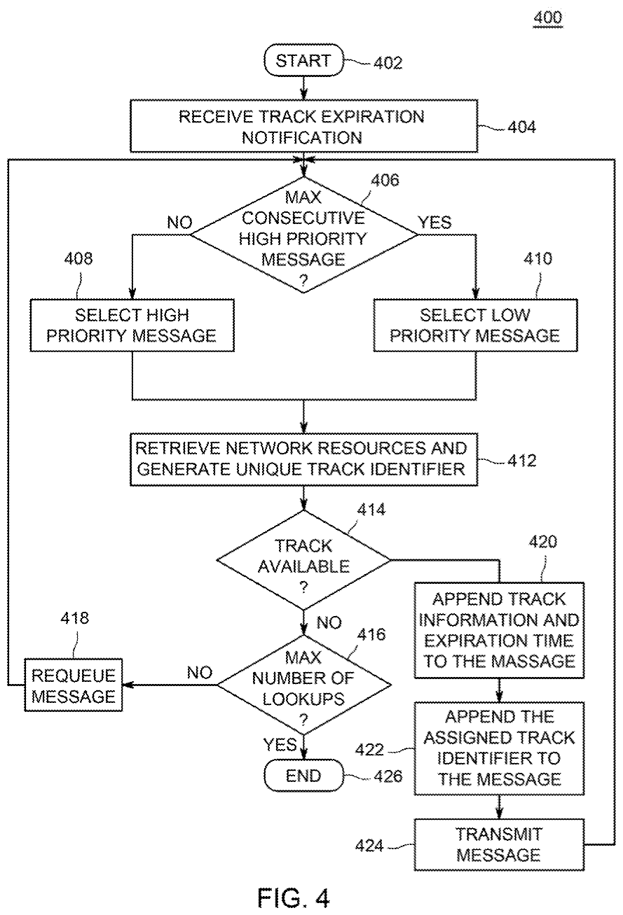

FIG. 4 is a flow diagram of a method 400 for managing message queues used to store messages that could not be allocated links by the method 300, according to one or more embodiments consistent with the present disclosure. In order to simplify the description, the method 400 is described with respect to two queue priorities: high and low; however, the method 400 may be implemented for one queue or as many priority queues are required. The queues in method 400 are implemented as first in first out (FIFO) queues. The method 400 starts at step 402 and proceeds to step 404.

At step 404, a track expiration notification is received. Link resources are freed up by the expiration of a track. In some embodiments, the notification may be received from the PCE. At step 406, the node selects a message from one of the queues based on their current sizes and the number of consecutive selections. The intent is to give more opportunity to high priority messages without starving to low priority ones. If at step 406, a maximum number of consecutive high priority messages has been reached, then the method proceeds to step 410 and retrieves a low priority message from one of the queues; however, if at step 406, the maximum number of consecutive high priority messages has not been reached, then the method proceeds to step 408 and retrieves a high priority message from the high priority queue.

At step 412, the node retrieves from the PCE the resources and creates a unique identifier for the track to send the retrieved message. At step 414, the node verifies whether network resources are available to route the message. If all network resources are currently in used and the sharing of link resources is not allowed or possible, then at step 416, the method attempts to allocate a track for a different destination up to pre-defined maximum number of lookups. If at step 416, the maximum number of lookups is not reached, the method proceeds to step 418, where the message is placed back in the associated priority queue and the method proceeds to step 406 to retrieve a next message from a queue. However, if at step 414, network resources are available, the method proceeds to step 420, where the link resources and track expiration time are appended to the message. At step 422 the track identifier is appended to the message. At step 424 the message is transmitted to the next node. The method then proceeds to step 406 to investigate whether tracks for other messages can be formed. If no messages are left on any queue, the method 400 ends.

FIGS. 5A, 5B, 5C, and 5D depict a sequence diagram 500 of two adjacent nodes, source node 102₁ on hop n and target node 102₄ on hop n+1 of a track according to one or more embodiments of the invention. The track is configured as the first message containing the track information is sent along the track's route. FIG. 5A depicts the default link resource assignments 502₁, 502₃, 502₅, 502₇, 502₉, and 502₁₁ on source node 102₁ and 502₂, 502₄, 502₆, 502₈, 502₁₀, and 502₁₂ on target node 102₄ before the track is configured. Each link is initially configured in reception (RX) (i.e., in listen mode) on the timeslots as default settings.

In FIG. 5B, the source node 102₁ receives the first message transferred using a track instructing the source node 102₁ to use timeslot 0 to transmit and in response, configures link 502₁ to transmission (TX)) to transmit the message to the next node, (in the present example, target node 102₄) on the track's route. The source node 102₁ then uses the just configured link 502₁ to send the message.

In FIG. 5C, the target node 102₄ receives the message with the track information and records the track ID, the timeslot and the channel offset it will use to listen for subsequent transmissions from the transmitting node (i.e., source node 102₁). The target node 102₄ also allocates and records the track information that indicates what links are to be used to transmit a return message to the source node 102₁. In the present example the return messages are sent in timeslot x+1 using the specified channel offset 506.

In FIG. 5D the target node 102₄ sends an acknowledgement 512 back to the source node 102₁. Upon reception of the acknowledgment, the source node 102₁ completes the allocation of the links specified in the message. The source node 102₁ records the track ID, track expiration time, and the channel offset (if specified) that will be used for subsequent forwarding of upstream and downstream traffic on this track. If the transmission of the acknowledgment fails, this process is completed by the retries on a shared timeslot. This process is repeated at each hop. Note that for the first message, the transfer of the message and the return of the acknowledgement are both performed using the default channel offset. For subsequent messages the target node 102₄ will transmit the acknowledgement using said channel offset. After both nodes receive the message with the appended track information and after the target 102₄ has acknowledged receipt, the two nodes are configured to send and receive subsequent messages using this track.

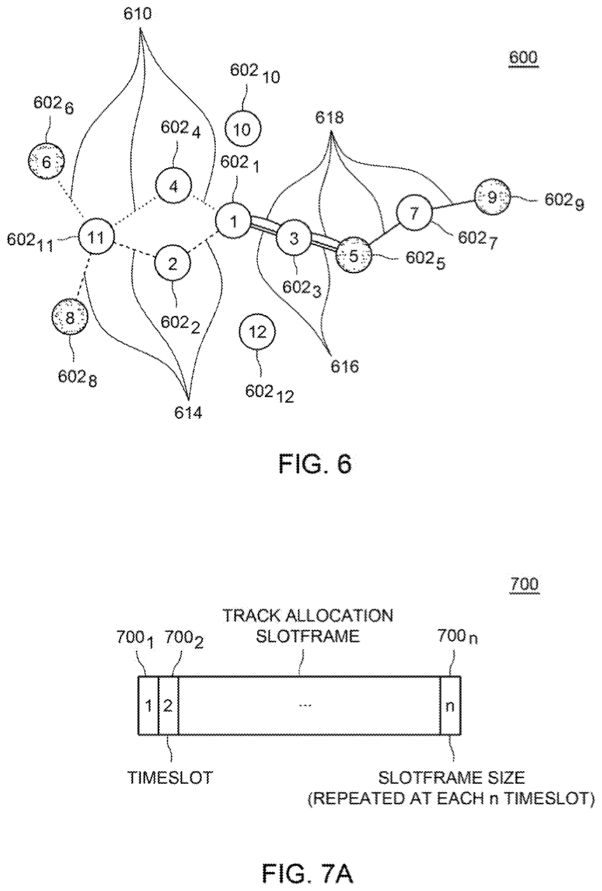

FIG. 6 depicts a diagram 600 of exemplary tracks established between different source and destination nodes, according to one or more embodiments of the invention. Track 614 connects node 602₁ to 602₈ through intermediate nodes 602₂ and 602₁₁. Track 610 connects node 602₁ to 602₆ through intermediate nodes 602₄ and 602₁₁. Track 616 connects node 602₁ to 602₅ through intermediate node 602₃. Track 618 connects node 602₁ to 602₉ through intermediate nodes 602₃, 602₅, and 602₇. In this exemplary implementation, tracks to nodes 602₅, and 602₉ share a link resource between nodes 602₁ and 602₃, and between nodes 602₃ and 602₅. In some embodiments, unique link resources may be assigned for tracks 616 and 618.

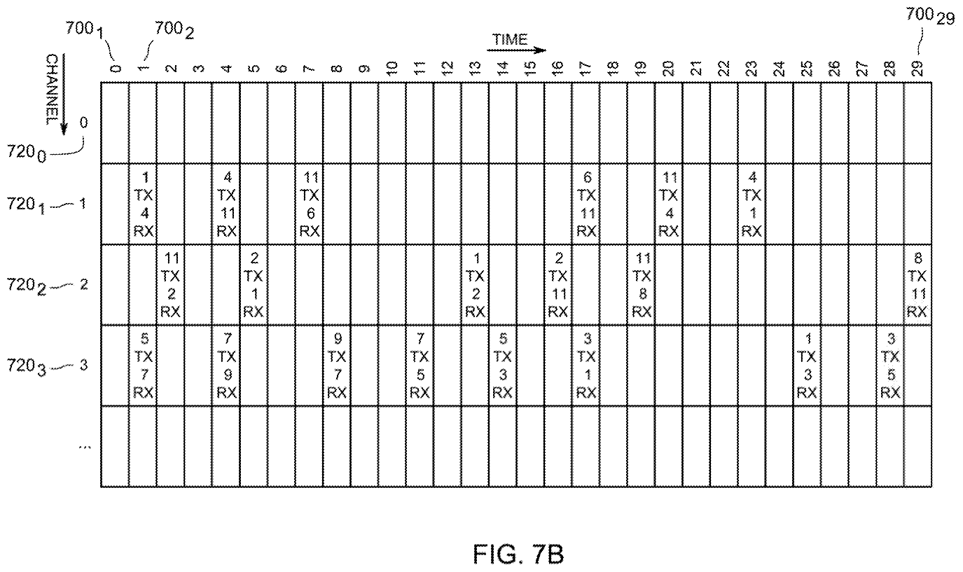

FIGS. 7A and 7B depict a possible slot frame and timeslots in a time-slotted channel hopping (TSCH) network for the example described by FIG. 6, according to one or more embodiments of the invention. In FIG. 7A, time is sliced up into timeslots 700₂, 700₄, 700ₙ (collectively referred to as timeslot 700). Each timeslot 700 is long enough for a Physical data unit (PDU) of maximum size to be sent from a first node to second node and an acknowledgement to be received back. Timeslots 700 are grouped into one or more slot frames. A TSCH schedule instructs each node what to do in each timeslot 700: transmit and/or receive, or sleep. FIG. 7B depicts the collective schedule for the tracks shown in FIG. 6. The schedule indicates, for each scheduled (transmit or receive) timeslot, a channelOffset 72₂, 720₄, . . . 720ₙ (collectively referred to as channelOffset 720). and the address of the neighbor node with which to communicate. Once a node obtains its schedule, the node executes the schedule: For each transmit timeslot, the node checks whether there is a message in the outgoing buffer that matches the neighbor written in the schedule information for that timeslot. If there is none, the node keeps its radio off for the duration of the timeslot. If there is a message, the message is transmitted. For each receive timeslot, the node listens for possible incoming messages. If none is received after some listening period within the timeslot, the node shuts down its radio. If a message is correctly received, addressed to the node, the node sends back an acknowledgment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A computer implemented method for dynamic track allocation in a network comprising:
accessing, at a first network node, a first message to be routed to a destination network node;
receiving from a path computation element (PCE), a defined track from the first network node to the destination network node, wherein the track includes at least the first network node, the destination network node, and any intermediate network nodes that provide a path from the first network node to the destination network node, wherein the track comprises one or more allocated link resources to the first network node, one or more allocated link resources to any intermediate network nodes, and one or more allocated link resources to the destination network node;
assigning a track identifier to the defined track;
assigning an expiration time to the defined track;
appending the allocated link resources, expiration time, and track identifier to the first message; and
transmitting the first message from the first network node to the destination network node, wherein transmitting causes subsequent messages with the same assigned track identifier to be routed through the network along the same route and using the link resources configured by the first message.

2. The method of claim 1, wherein a link resource is a timeslot, channel offset, and next hop destination address on a network node.

3. The method of claim 1, wherein the one or more link resources are shared with one or more defined tracks.

4. The method of claim 1, wherein the first network node is a border router.

5. The method of claim 1, wherein the path computational element is not on a network node.

6. The method of claim 1, wherein the first network node comprises a path computation element.

7. The method of claim 1, wherein the first message is be assigned a track are queued until link resources are available.

8. The method of claim 7, wherein messages are stored in more than one priority queue.

9. The method of claim 1, wherein tracks are timed out according to an assigned expiration time and all track link assignments are retained by all nodes in the defined track until the track has expired.

10. A system for dynamic track allocation in a network, comprising:
a plurality of nodes, wherein each node comprises:
a) at least one processor;
b) at least one input device; and
c) at least one storage device storing processor-executable instructions track information, and one or more message queues which, when executed by the at least one processor, perform a method including: accessing, at a first network node, a first message to be routed to a destination network node;
receiving from a path computation element (PCE), a defined track from the first network node to the destination network node, wherein the track includes at least the first network node, the destination network node, and any intermediate network nodes that provide a path from the first network node to the destination network node, wherein the track comprises one or more allocated link resources to the first network node, one or more allocated link resources to any intermediate network nodes, and one or more allocated link resources to the destination network node;
assigning a track identifier to the defined track;
assigning an expiration time to the defined track;
appending the allocated link resources, expiration time, and track identifier to the first message; and
transmitting the first message from the first network node to the destination network node, wherein transmitting causes subsequent messages with the same assigned track identifier to be routed through the network along the same route and using the link resources configured by the first message.

11. The system of claim 10, wherein a link resource is a timeslot, channel offset, and next hop destination address on a network node.

12. The system of claim 10, wherein the one or more link resources are shared with one or more defined tracks.

13. The system of claim 10, wherein the first network node is a border router.

14. The system of claim 10, wherein the path computational element is not on a network node.

15. The system of claim 10, wherein the first network node comprises a path computation element.

16. The system of claim 10, wherein the first message is be assigned a track are queued until link resources are available.

17. The system of claim 16, wherein messages are stored in more than one priority queue.

18. The system of claim 10, wherein tracks are timed out according to an assigned expiration time and all track link assignments are retained by all nodes in the defined track until the track has expired.

19. A non-transitory computer readable medium for storing computer instructions that, when executed by at least one processor causes the at least one processor to perform a method for dynamic track allocation, comprising:
accessing, at a first network node, a first message to be routed to a destination network node;
receiving from a path computation element (PCE), a defined track from the first network node to the destination network node, wherein the track includes at least the first network node, the destination network node, and any intermediate network nodes that provide a path from the first network node to the destination network node, wherein the track comprises one or more allocated link resources to the first network node, one or more allocated link resources to any intermediate network nodes, and one or more allocated link resources to the destination network node;
assigning a track identifier to the defined track;
assigning an expiration time to the defined track;
appending the allocated link resources, expiration time, and track identifier to the first message; and
transmitting the first message from the first network node to the destination network node, wherein transmitting causes subsequent messages with the same assigned track identifier to be routed through the network along the same route and using the link resources configured by the first message.

20. The non-transitory computer readable medium of claim 19, wherein a link resource is a timeslot, channel offset, and next hop destination address on a network node, and wherein the one or more link resources are shared with one or more defined tracks.
